(19) United States
(12) Patent Application Publication
(10) Pub. No.: US 2014/0306460 A1
(43) Pub. Date: Oct. 16, 2014

(54) HIGH SPEED DIRECT DRIVE GENERATOR FOR A GAS TURBINE ENGINE

(71) Applicant: ICR Turbine Engine Corporation, Hampton, NH (US)

(72) Inventor: Frank Wegner Donnelly, North Vancouver (CA)

(73) Assignee: ICR Turbine Engine Corporation, Hampton, NH (US)

(21) Appl. No.: 14/254,699

(22) Filed: Apr. 16, 2014

Related U.S. Application Data
(60) Provisional application No. 61/812,407, filed on Apr. 16, 2013.

(51) Int. Cl. F02B 63/04; F02C 6/00

(52) U.S. Cl. CPC F02B 63/042; F02C 6/00
USPC 290/1 A

(57) ABSTRACT

A motor/generator apparatus for direct coupling to a high rpm, high power shaft is disclosed for one or more of starting and/or extracting power from a gas turbine engine, controlling engine responsiveness, providing a temporary power boost, providing some engine braking and modulating compressor and turbine transient performance as engine power is changed. For example, an axial flux motor/generator configuration is disclosed in which a centrifugal gas compressor rotor is also the rotor of an axial electrical flux motor/generator. In addition, an induction motor/generator is disclosed wherein the rotor of the induction electrical motor/generator is solid and is made of copper-clad steel or titanium. This construction enables both high rpm and high power in a motor/generator that can be directly coupled to the power output shaft of a power turbine of a gas turbine engine.

### CROSS REFERENCE TO RELATED APPLICATION

The present application claims the benefits under 35 U.S.C.§119(e), of U.S. Provisional Application Ser. No. 61/812,407 entitled “High Speed Direct Drive Generator for a Gas Turbine Engine” filed Apr. 16, 2013 which is incorporated herein by reference.

### FIELD

The present invention relates generally to a high-speed direct-drive generator for a gas turbine engine for application to output power, starting the engine and to modulating engine responsiveness.

### BACKGROUND

There is a growing requirement for alternate fuels for vehicle propulsion and power generation. These include fuels such as natural gas, bio-diesel, ethanol, butanol, hydrogen and the like. Means of utilizing fuels needs to be accomplished more efficiently and with substantially lower carbon dioxide emissions and other air pollutants such as NOx.

The gas turbine or Brayton cycle power plant has demonstrated many attractive features which make it a candidate for advanced vehicular propulsion as well as power generation. Gas turbine engines have the advantage of being highly fuel flexible and fuel tolerant. Additionally, these engines burn fuel at a lower temperature than comparable reciprocating engines so produce substantially less NOx per mass of fuel burned.

A multi-spool intercooled, recuperated gas turbine system is particularly suited for use as a power plant for a vehicle, especially a truck, bus or other overland vehicle. However, it has broader applications and may be used in many different environments and applications, including as a stationary electric power module for distributed power generation.

Vehicular applications, such as large trucks and buses, demand a very wide power range of operation. The multi-spool configurations described herein create opportunities to improve engine start-up, to improve engine responsiveness and to control the engine to over a broad output power range.

A conventional gas turbine may be composed of two or more turbo-compressor spools to achieve progressively higher pressure ratio. A prior art turbine engine composed of three independent rotating assemblies or spools, including a high pressure turbo-compressor spool, a low pressure turbo-compressor spool and a free power turbine spool is described in U.S. Patent Application Publication No. 2013/0139519, which is incorporated by reference herein. Both the high and low pressure spools are composed of a compressor, a turbine, and a shaft connecting the two. The free turbine spool is composed of a turbine, a load device, and a shaft connecting the two. The load device is normally a generator power generation or a transmission for a vehicular application. A combustor is used to heat the air between the recuperator and high pressure turbine.

A common method for starting a turbo machine is to provide an electro-mechanical motive power to the high pressure spool. A motor/clutch is engaged to provide rotary power to the high pressure spool. Once the high pressure spool is supplied with power, air flow within the cycle occurs, enabling the fuel to be admitted into the combustor and the subsequent initiation of combustion. Hot pressurized gas from the high pressure spool is then delivered to the low pressure spool and the free turbine spool.

U.S. Patent Application Publication No. 2013/0139519 describes several methods of starting such a multi-spool engine including the use of a combined motor/generator device coupled to the electrical system of a vehicle such that the vehicle power supply may be used to operate the motor/generator device for starting the gas turbine and, after the gas turbine has been started, for converting a portion of the rotational power of the high pressure spool to electrical power.

A starter device on the high pressure spool may be able to start a multi-spool engine rapidly and efficiently and has been contemplated for use in controlling engine performance and responsiveness as described in U.S. Patent Application Publication No. 2012/0000204, which is incorporated by reference herein. However, use of motor/generators on more than one turbo-compressor spool and use of a generator on the power output shaft of an engine typically require reducing gear boxes to match high rpm spool speeds with available generators which typically operate at lower rpms. These gear boxes take up valuable space especially when a compact engine is desirable.

There therefore remains a need for innovative motor/generator devices that can operate at the high rpms, high power and still retain the compactness desired for gas turbine engines by eliminating the need for bulky gearboxes and/or combining the electrical components with existing turbo-compressor mechanical components.

### SUMMARY

These and other needs are addressed by the various embodiments and configurations of the present disclosure which are directed generally to a motor/generator apparatus for one or more of starting and/or extracting power from a gas turbine engine, controlling engine responsiveness, providing a temporary power boost, providing some engine braking and modulating compressor and turbine transient performance as engine power is changed. A motor/generator apparatus for direct coupling to a high rpm, high power shaft is also disclosed.

In a first embodiment, an axial flux motor/generator configuration is disclosed in which a centrifugal gas compressor rotor also serves as the rotor of an axial electrical flux motor/generator. In this configuration, the stator of the axial flux device is integrated into the housing of the centrifugal compressor. In another configuration, a separate disk mounted on the gas compressor shaft serves as the axial electrical flux motor/generator rotor. In yet another configuration, the preceding two configurations may be applied to the gas turbine rotor, although this is less preferable because temperatures associated with the gas turbine are considerably higher than the temperatures associated with its corresponding gas compressor.

In a second embodiment, an induction motor/generator is disclosed wherein the rotor of the induction electrical motor/generator is solid and is made of copper-clad steel. This construction enables both high rpm (up to about 100,000 rpm) and high power (up to about 400 kW) in a motor/generator that can be directly coupled to the power output shaft of a power turbine of a gas turbine engine. The induction motor/generator with a copper-clad rotor is a high rpm, high-power compact direct-drive induction generator that can eliminate the need for a gear box for an electric or hybrid transmission.

In a third embodiment, an electrical induction motor/generator is disclosed in which the copper clad shaft of the gas turbo-compressor forms the rotor. The rotor and and stator serve as a bearing or damper for the gas turbo-compressor shaft.

In summary, a gas turbine engine is disclosed comprising 1) a combustor operable to combust a fuel and air mixture, the combustor having an inlet and an outlet, 2) at least one turbo-compressor spool comprising a compressor rotor housing, a compressor rotor positioned within the compressor rotor housing, a turbine rotor housing, a turbine rotor positioned within the turbine rotor housing, and a shaft connecting the compressor rotor and the turbine rotor, the compressor rotor being associated with the combustor inlet and the turbine rotor being associated with the combustor outlet, wherein at least one of the compressor rotor housing and the turbine rotor housing comprises a stator; wherein at least one of a rear surface of the compressor rotor and a rear surface of the turbine rotor has a layer of copper cladding in proximity to the stator and wherein at least one of the compressor rotor housing and the turbine rotor housing includes magnetic core and current-carrying windings wherein an air gap magnetic field is produced in the current-carrying windings by the rotation of the at least one of the compressor rotor and the turbine rotor, the stator and the cladded rotor defining an electrical axial flux motor/generator.

These and other advantages will be apparent from the disclosure of the invention(s) contained herein.

The above-described embodiments and configurations are neither complete nor exhaustive. As will be appreciated, other embodiments of the invention are possible utilizing, alone or in combination, one or more of the features set forth above or described in detail below.

The following definitions are used herein:

The term automatic and variations thereof, as used herein, refers to any process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material”.

Amorphous steel is formed by a metallic glass over which is poured a molten alloy steel and then cooled so rapidly that crystals do not form. Amorphous steel cores can have core losses of one-third that of conventional steels. Amorphous steel has poorer mechanical properties than conventional steel.

The term computer-readable medium as used herein refers to any tangible storage and/or transmission medium that participate in providing instructions to a processor for execution. Such a medium may take many forms, including but not limited to, non-volatile media, volatile media, and transmission media. Non-volatile media includes, for example, NVRAM, or magnetic or optical disks. Volatile media includes dynamic memory, such as main memory. Common forms of computer-readable media include, for example, a floppy disk, a flexible disk, hard disk, magnetic tape, or any other magnetic medium, magneto-optical medium, a CD-ROM, any other optical medium, punch cards, paper tape, any other physical medium with patterns of holes, a RAM, a PROM, and EPROM, a FLASH-EPROM, a solid state medium like a memory card, any other memory chip or cartridge, a carrier wave as described hereinafter, or any other medium from which a computer can read. A digital file attachment to e-mail or other self-contained information archive or set of archives is considered a distribution medium equivalent to a tangible storage medium. When the computer-readable media is configured as a database, it is to be understood that the database may be any type of database, such as relational, hierarchical, object-oriented, and/or the like. Accordingly, the disclosure is considered to include a tangible storage medium or distribution medium and prior art-recognized equivalents and successor media, in which the software implementations of the present disclosure are stored.

The terms determine, calculate and compute, and variations thereof, as used herein, are used interchangeably and include any type of methodology, process, mathematical operation or technique.

Electrical steel, also called lamination steel, silicon electrical steel, silicon steel, relay steel or transformer steel, is specialty steel tailored to produce certain magnetic properties, such as a low hysteresis energy dissipation and high permeability.

Energy density as used herein is energy per unit volume (joules per cubic meter).

An energy storage system refers to any apparatus that acquires, stores and distributes mechanical, electrical or heat energy which is produced from another energy source such as a prime energy source, a regenerative braking system, a third rail and a catenary and any external source of electrical energy. Examples are a battery pack, a bank of capacitors, a pumped storage facility, a compressed air storage system, an array of a heat storage blocks, a bank of flywheels or a combination of storage systems.

An engine is a prime mover and refers to any device that uses energy to develop mechanical power, such as motion in some other machine. Examples are diesel engines, gas turbine engines, microturbines, Stirling engines and spark ignition engines.

Ferrites are usually non-conductive ferromagnetic ceramic compounds derived from iron oxides such as hematite or magnetite as well as oxides of other metals. Ferrites are, like most other ceramics, hard and brittle. In terms of their magnetic properties, the different ferrites are often classified as soft or hard, which refers to their low or high magnetic coercivity. Soft ferrites that are used in transformer or electromagnetic cores contain nickel, zinc, and/or manganese compounds. The low coercivity means the material's magnetization can easily reverse direction without dissipating much energy (hysteresis losses), while the material's high resistivity prevents eddy currents in the core, another source of energy loss. Because of their comparatively low losses at high frequencies, they are extensively used in the cores of RF transformers and inductors in applications such as switched-mode power supplies. In contrast, permanent ferrite magnets are made of hard ferrites, which have a high coercivity and high remanence after magnetization. These are composed of iron oxide and barium or strontium carbonate. The high coercivity means the materials are very resistant to becoming demagnetized, an essential characteristic for a permanent magnet. They also conduct magnetic flux well and have a high magnetic permeability. This enables these so-called ceramic magnets to store stronger magnetic fields than iron itself.

A gasifier is that portion of a gas turbine engine that produce the energy in the form of pressurized hot gasses that can then be expanded across the free power turbine to produce energy.

A gas turbine engine as used herein may also be referred to as a turbine engine or microturbine engine. A microturbine is commonly a sub category under the class of prime movers called gas turbines and is typically a gas turbine with an output power in the approximate range of about a few kilowatts to about 700 kilowatts. A turbine or gas turbine engine is commonly used to describe engines with output power in the range above about 700 kilowatts. As can be appreciated, a gas turbine engine can be a microturbine since the engines may be similar in architecture but differing in output power level. The power level at which a microturbine becomes a turbine engine is arbitrary and the distinction has no meaning as used herein.

A hybrid transmission as used herein is a transmission that includes mechanical gears and linkages for transmitting power from an engine to a drive shaft as well as electrical devices such as generators and traction motors also capable of transmitting power from an engine to a drive shaft. Such a transmission may operate at different times as a purely mechanical, a purely electrical or a combination of mechanical and electrical transmission. A hybrid transmission includes the capability to generate electrical energy, for example while braking

Jake brake or Jacobs brake describes a particular brand of engine braking system. It is used generically to refer to engine brakes or compression release engine brakes in general, especially on large vehicles or heavy equipment. An engine brake is a braking system used primarily on semi-trucks or other large vehicles that modifies engine valve operation to use engine compression to slow the vehicle. They are also known as compression release engine brakes.

A mechanical-to-electrical energy conversion device refers an apparatus that converts mechanical energy to electrical energy or electrical energy to mechanical energy. It is also referred to herein as a motor/generator. Examples include but are not limited to a synchronous alternator such as a wound rotor alternator or a permanent magnet machine, an asynchronous alternator such as an induction alternator, a DC generator, and a switched reluctance generator. A traction motor is a mechanical-to-electrical energy conversion device used primarily for propulsion. The word generator is used interchangeably with alternator herein except as specifically noted.

The term module as used herein refers to any known or later developed hardware, software, firmware, artificial intelligence, fuzzy logic, or combination of hardware and software that is capable of performing the functionality associated with that element. Also, while the disclosure is presented in terms of exemplary embodiments, it should be appreciated that individual aspects of the disclosure can be separately claimed.

A permanent magnet motor is a synchronous rotating electric machine where the stator is a multi-phase stator like that of an induction motor and the rotor has surface-mounted permanent magnets. In this respect, the permanent magnet synchronous motor is equivalent to an induction motor where the air gap magnetic field is produced by a permanent magnet. The use of a permanent magnet to generate a substantial air gap magnetic flux makes it possible to design highly efficient motors. For a common 3-phase permanent magnet synchronous motor, a standard 3-phase power stage is used. The power stage utilizes six power transistors with independent switching. The power transistors are switched in ways to allow the motor to generate power, to be free-wheeling or to act as a generator by controlling frequency.

A prime power source refers to any device that uses energy to develop mechanical or electrical power, such as motion in some other machine. Examples are diesel engines, gas turbine engines, microturbines, Stirling engines, spark ignition engines and fuel cells.

A power control apparatus refers to an electrical apparatus that regulates, modulates or modifies AC or DC electrical power. Examples are an inverter, a chopper circuit, a boost circuit, a buck circuit or a buck/boost circuit.

Power density as used herein is power per unit volume (watts per cubic meter).

A recuperator as used herein is a gas-to-gas heat exchanger dedicated to returning exhaust heat energy from a process back into the pre-combustion process to increase process efficiency. In a gas turbine thermodynamic cycle, heat energy is transferred from the turbine discharge to the combustor inlet gas stream, thereby reducing heating required by fuel to achieve a requisite firing temperature.

A regenerator is a heat exchanger that transfers heat by submerging a matrix alternately in the hot and then the cold gas streams wherein the flow on the hot side of the heat exchanger is typically exhaust gas and the flow on cold side of the heat exchanger is typically gas entering the combustion chamber.

A reheat or reheater apparatus, as used herein, is an apparatus that can burn or react an air-fuel mixture wherein the apparatus is downstream of the highest pressure turbine in a Brayton cycle gas turbine system.

Specific energy as used herein is energy per unit mass (joules per kilogram).

Specific power as used herein is power per unit mass (watts per kilogram).

Spool means a group of turbo machinery components on a common shaft. A turbo-compressor spool is a spool comprised of a compressor and a turbine connected by a shaft. A free power turbine spool is a spool comprised of a turbine and a turbine power output shaft.

A switch as used herein is an electrical component that can break an electrical circuit, interrupting the current or diverting it from one conductor to another. A switch may be directly manipulated by a human as a control signal to a system, such as a computer keyboard button, or to control power flow in a circuit, such as a light switch. Automatically operated switches can be used to control the motions of machines. Switches may be operated by process variables such as pressure, temperature, flow, current, voltage, and force, acting as sensors in a process and used to automatically control a system. A switch that is operated by another electrical circuit is called a relay. Solid-state relays control power circuits with no moving parts, instead using a semiconductor device to perform switching—often a silicon-controlled rectifier or triac. The analogue switch uses two MOSFET transistors in a transmission gate arrangement as a switch that works much like a relay, with some advantages and several limitations compared to an electromechanical relay. The power transistor(s) in a switching voltage regulator, such as a power supply unit, are used like a switch to alternately let power flow and block power from flowing. The common feature of all these usages is they refer to devices that control a binary state: they are either on or off, closed or open, connected or not connected.

A thermal energy storage (“TES”) module is a device that includes either a metallic heat storage element or a ceramic heat storage element with embedded electrically conductive wires. A thermal energy storage module is similar to a heat storage block but is typically smaller in size and energy storage capacity.

A thermal oxidizer is a type of combustor comprised of a matrix material which is typically a ceramic and a large number of channels which are typically circular in cross section. When a fuel-air mixture is passed through the thermal oxidizer, it begins to react as it flows along the channels until it is fully reacted when it exits the thermal oxidizer. A thermal oxidizer is characterized by a smooth combustion process as the flow down the channels is effectively one-dimensional fully developed flow with a marked absence of hot spots.

A thermal reactor, as used herein, is another name for a thermal oxidizer.

A turbine is any machine in which mechanical work is extracted from a moving fluid by expanding the fluid from a higher pressure to a lower pressure.

Turbine Inlet Temperature (TIT) as used herein refers to the gas temperature at the outlet of the combustor which is closely connected to the inlet of the high pressure turbine and these are generally taken to be the same temperature. Turbine Inlet Temperature can also refer to the temperature at the inlet of any turbine in the engine.

As used herein, “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

The preceding is a simplified summary of the disclosure to provide an understanding of some aspects of the disclosure. This summary is neither an extensive nor exhaustive overview of the disclosure and its various aspects, embodiments, and/or configurations. It is intended neither to identify key or critical elements of the disclosure nor to delineate the scope of the disclosure but to present selected concepts of the disclosure in a simplified form as an introduction to the more detailed description presented below. As will be appreciated, other aspects, embodiments, and/or configurations of the disclosure are possible utilizing, alone or in combination, one or more of the features set forth above or described in detail below.

### BRIEF DESCRIPTION OF THE DRAWINGS

The disclosure may take form in various components and arrangements of components, and in various steps and arrangements of steps. The drawings are only for purposes of illustrating the preferred embodiments and are not to be construed as limiting the invention. In the drawings, like reference numerals refer to like or analogous components throughout the several views.

It should be understood that the drawings are not necessarily to scale. In certain instances, details that are not necessary for an understanding of the disclosure or that render other details difficult to perceive may have been omitted. It should be understood, of course, that the disclosure is not necessarily limited to the particular embodiments illustrated herein.

FIG. 1 is a schematic of a prior art gas turbine engine architecture including motor/generators locations of the present disclosure.

FIG. 2 is a turbo-compressor spool showing a metallic compressor rotor and a ceramic turbine rotor.

FIG. 3 is a table showing typical rpms and power ratings for motor/generator locations.

FIG. 4 is a table showing typical full power pressures and temperatures for the engine of FIG. 1.

FIG. 5a is a rear elevation view of a compressor rotor and housing configured as an axial flux motor/generator rotor and stator.

FIG. 5b side elevation view of a compressor rotor and housing configured as an axial flux motor/generator rotor and stator.

FIG. 5c front elevation view of a compressor rotor and housing configured as an axial flux motor/generator rotor and stator.

FIG. 6a is another rear elevation view of a compressor rotor and housing configured as an axial flux motor/generator rotor and stator.

FIG. 6b is another side elevation view of a compressor rotor and housing configured as an axial flux motor/generator rotor and stator.

FIG. 6c is another front elevation view of a compressor rotor and housing configured as an axial flux motor/generator rotor and stator.

FIG. 7 illustrates a close-up view of a compressor rotor and housing configured as an axial flux motor/generator rotor and stator.

FIG. 8 illustrates an induction machine with a copper-clad solid steel rotor directly coupled to the output shaft of a power turbine.

FIG. 9 illustrates an induction motor whose stator also forms a bearing for the turbo-compressor spool shaft.

FIG. 10 illustrates a close-up view of an induction motor whose stator also forms a bearing for the turbo-compressor spool shaft.

To assist in the understanding of one embodiment of the present disclosure the following list of components and associated numbering found in the drawings is provided herein:

| Component | # |
|---|---|
| Gas Compressor Rotor | 1 |
| Compressor Housing | 2 |
| Turbo-Compressor Rotor Shaft | 3 |
| Gas Compressor Rotor Blades | 4 |
| Gas Compressor Rotor Diameter | 5 |
| Electrical Generator Stator | 6 |
| Electrical Generator Rotor | 7 |
| Diameter of Generator Rotor Cladding | 8 |
| Generator Stator Winding Grooves | 9 |
| Prior Art Generator Housing | 21 |
| Prior Art Generator Rotor | 22 |
| Prior Art Generator Rotor Shaft | 23 |
| Prior Art Generator Stator | 24 |
| Free Power Turbine | 31 |
| Power Turbine Power Output Shaft | 32 |
| Generator Stator | 33 |
| Generator Rotor | 34 |
| Engine Inlet | 51 |
| Low-Pressure Spool | 52 |
| High-Pressure Spool | 53 |
| Free Power Turbine Spool | 54 |
| Low-Pressure Compressor | 55 |
| Intercooler | 56 |
| High-Pressure Compressor | 57 |
| Recuperator | 58 |
| Combustor | 59 |
| High-Pressure Turbine | 60 |
| Low-Pressure Turbine | 61 |
| Variable Area Nozzle | 62 |
| Free Power Turbine | 63 |
| Power Output Motor/generator | 64 |
| Electric Motor/generator | 65 |
| Engine Exhaust | 66 |
| Compressor Inlet | 67 |
| Turbine Rotor | 68 |
| Rotor Shaft Cladding | 71 |
| Stator Inner Diameter Material | 72 |
| Shaft Bearings | 73 |
| Metal-to-Ceramic Joint | 75 |

### DETAILED DESCRIPTION

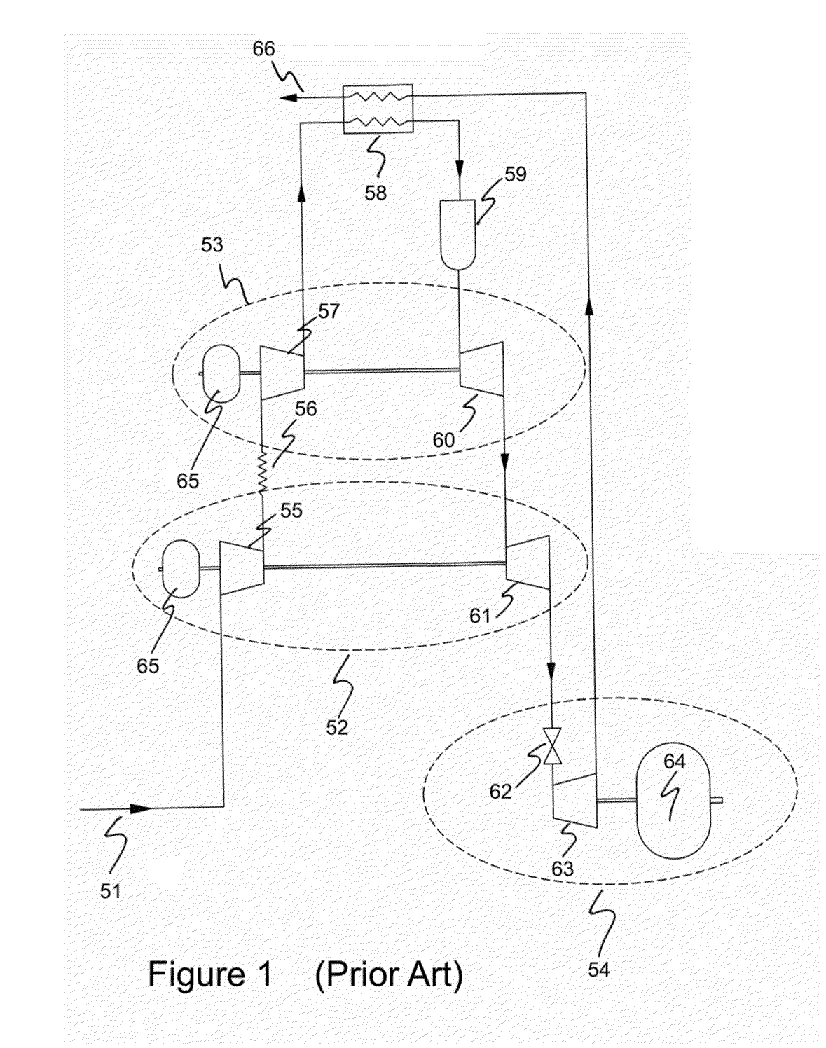

FIG. 1 is a schematic of a prior art gas turbine engine architecture including electrical motor/generators locations of the present disclosure. FIG. 1 illustrates a turbo-machine comprised of three independent spools. Two are nested turbo-compressor spools and one is a free power turbine spool connected to a load device. A conventional gas turbine may be comprised of two or more turbo-compressor spools to achieve a progressively higher pressure ratio. FIG. 1 shows a turbo-machine composed of three independent rotating assemblies or spools, including a high pressure turbo-compressor spool 53, a low pressure turbo-compressor spool 52, and a free power turbine spool 54. As seen in FIG. 1, the high pressure spool 53 is comprised of a compressor 57, a turbine 60, and a small motor/generator 65. The low pressure spool 52 is comprised of a compressor 55, a turbine 61, and another small motor/generator 65. The free power turbine spool 54 is comprised of a turbine 63, a variable area nozzle 62 and a load device 64 which can be a motor/generator capable of high power operation. A combustor 59 is used to combust fuel and further heat the air between a recuperator 58 and high pressure turbine 60. In operation, gas is ingested via inlet 51 into a low pressure compressor 55. The outlet of the low pressure compressor 55 passes through an intercooler 56 which removes a portion of heat from the gas stream at approximately constant pressure. The gas then enters a high pressure compressor 57. The outlet of high pressure compressor 57 passes through the cold side of a recuperator 58 where a portion of heat from the exhaust gas is transferred, at approximately constant pressure, to the gas flow from the high pressure compressor 57. The further heated gas from the cold side of recuperator 58 is then directed to a combustor 59 where a fuel is burned, adding heat energy to the gas flow at approximately constant pressure. The gas emerging from the combustor 59 then enters a high pressure turbine 60 where work is done by turbine 60 to operate high pressure compressor 57. The gas from the high pressure turbine 60 then drives low pressure turbine 61 where work is done by turbine 61 to operate low pressure compressor 55. The gas exiting from low pressure turbine 61 then passes through variable area nozzle 62 and enters free power turbine 63. The shaft of free power turbine 63, in turn, drives a load 64 which, in this example, is a motor/generator. Finally, the gas exiting free power turbine 63 flows through the hot side of the recuperator 58 where heat is extracted and used to preheat the gas just prior to entering the combustor. The gas exiting the hot side of the recuperator is then exhausted via exhaust 66 the atmosphere. This engine configuration is discussed in U.S. Patent Application Publication No. 2013/0139519.

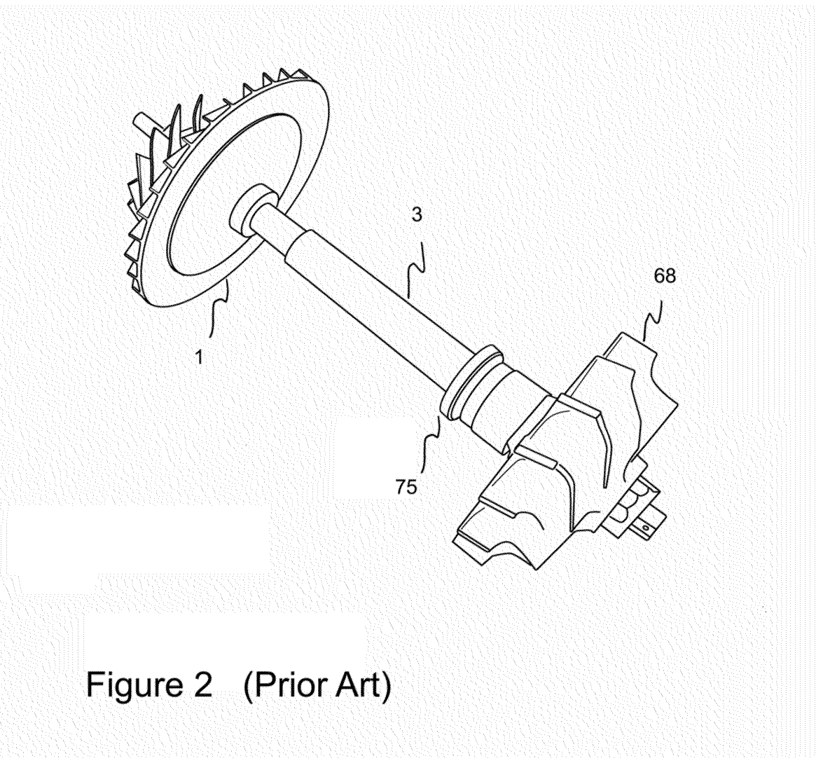

FIG. 2 is a schematic of a prior art turbo-compressor spool showing a metallic compressor rotor and a ceramic turbine rotor. This figure illustrates a compressor/turbine spool typical of a high-pressure spool in a high-efficiency gas turbine engine operating in the output power range as high as about 300 to about 750 kW. A metallic compressor rotor 1 and a ceramic turbine rotor 68 are shown attached to the opposite ends of a metal shaft 3. The ceramic rotor shown here is a 95-mm diameter rotor fabricated typically from silicon nitride and was originally designed for use in turbocharger applications. As can be seen, the joint 75 between the ceramic rotor and metallic shaft is close to the ceramic rotor and is therefore exposed to high temperatures of the combustion products passing through the turbine. Typical turbine inlet temperatures for this design are in the range of about 1,250° K to about 1,400° K.

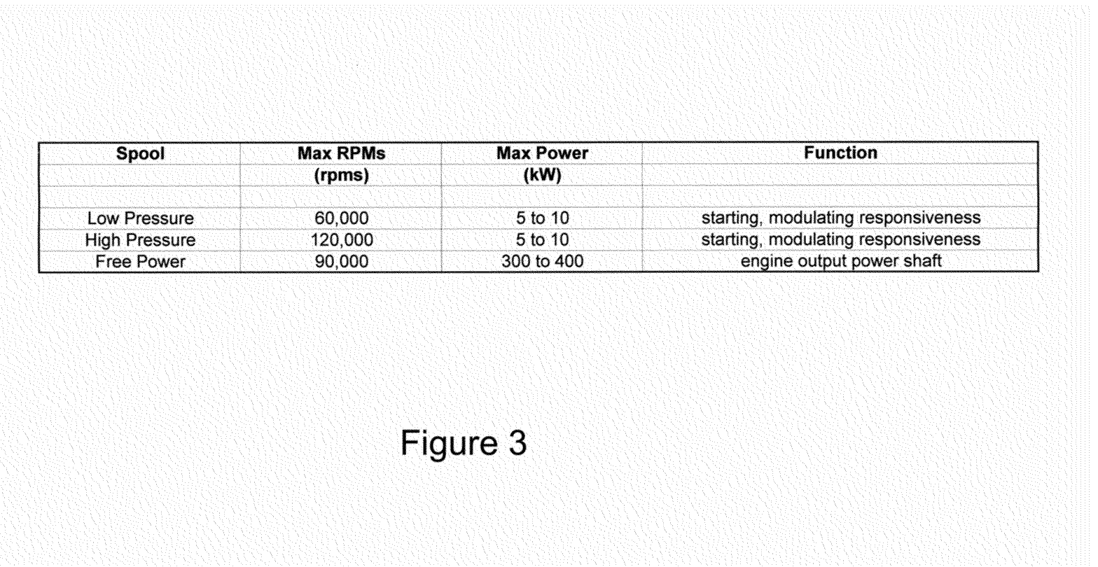

FIG. 3 is a table showing rpms and power ratings for electrical motor/generator locations shown in FIG. 1 for a gas turbine engine operating in the output power range of about 300 to about 750 kW. A small electrical motor/generator may be used on the high pressure spool such as shown in FIG. 1. This could be an electrical generator with power output in the range of about 1 kW to about 10 kW. Such a motor/generator could be used as a starter motor and as a control device on the high pressure spool by adding or extracting small amounts of power when required. This capability is described in U.S. Patent Application Publication Nos. 2013/0139519 and 2012/0000204.

A small electrical motor/generator may also be used on the low pressure spool such as shown in FIG. 1. This could be an electrical generator with power output also in the range of about 1 kW to about 10 kW. Such a motor/generator could be used as an alternate or additional starter motor and as a control device on the low pressure spool by adding or extracting small amounts of power when required.

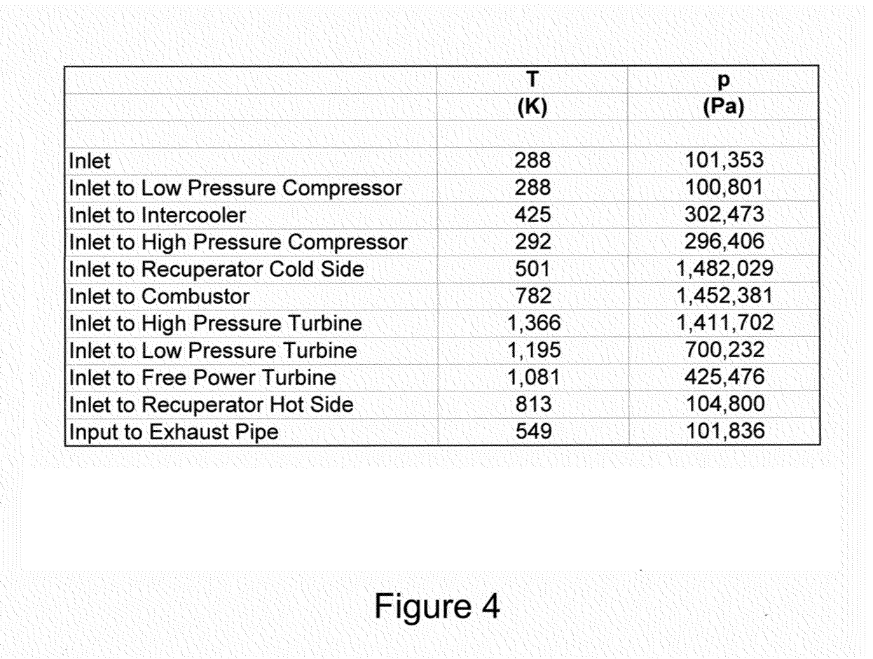

FIG. 4 is a table showing typical full power pressures and temperatures for the various components of the gas turbine engine of FIG. 1 for a gas turbine engine operating in the output power range of about 300 to about 750 kW. From this table, it can be seen that the temperatures associated with the gas compressors on a spool are lower than those associated with the gas turbines. Therefore it is preferable to integrate an axial flux electrical motor/generator, for example, with a gas compressor rotor and housing rather than with a gas turbine rotor and housing in a turbo-compressor spool.

### Present Disclosure

The configurations of the present disclosure are directed generally to a motor/generator apparatus for one or more of starting and/or extracting power from a gas turbine engine, controlling engine responsiveness, providing a temporary power boost, providing some engine braking and modulating compressor and turbine transient performance as engine power is changed.

The motor/generator configurations described herein are enabled by welding techniques that can be used to form compact high-rpm electrical rotors by copper cladding a suitable solid rotor made, for example, out of high-strength steel or a titanium alloy. There are several welding techniques that may be applied to accomplish this copper cladding. These include, for example,
1) Explosion welding or bonding is a solid state welding process that is used for the metallurgical joining of dissimilar metals. The process uses the forces of controlled detonations to accelerate one metal plate into another creating a bond.
2) Gas dynamic cold spray is a coating deposition method in which solid powders (1 to 50 micrometers in diameter) are accelerated in supersonic gas jets to velocities up to 500 to 1000 m/s. During impact with the substrate, particles undergo plastic deformation and adhere to the surface.
3) Friction welding is a class of solid-state welding processes that generate heat through mechanical friction between a moving workpiece and a stationary component, with the addition of a lateral force called “upset” to plastically displace and fuse the materials.
4) Spin welding systems consist of two chucks for holding the materials to be welded, one of which is fixed and the other rotating. Before welding one of the work pieces is attached to the rotating chuck along with a flywheel of a given weight. The piece is then spun up to a high rate of rotation to store the required energy in the flywheel. Once spinning at the proper speed, the motor is removed and the pieces forced together under pressure.
5) Linear friction welding is similar to spin welding except that the moving chuck oscillates laterally instead of spinning The speeds are much lower in general, which requires the pieces to be kept under pressure at all times.
6) Friction surfacing is a process derived from friction welding where a coating material is applied to a substrate. A rod composed of the coating material is rotated under pressure, generating a plasticized layer in the rod at the interface with the substrate. By moving a substrate across the face of the rotating rod a plasticized layer is deposited.
7) In linear vibration welding, the materials are placed in contact and put under pressure. An external vibration force is then applied to slip the pieces relative to each other, perpendicular to the pressure being applied. The parts are vibrated through a relatively small displacement.
8) Orbital friction welding is similar to spin welding, but uses a more complex machine to produce an orbital motion in which the moving part rotates in a small circle, much smaller than the size of the joint as a whole.
9) Physical vapor deposition is a variety of vacuum deposition methods used to deposit thin films by the condensation of a vaporized form of the desired film material onto various workpiece surfaces. The coating method involves purely physical processes such as high temperature vacuum evaporation with subsequent condensation, or plasma sputter bombardment
10) Chemical vapor deposition is a chemical process used to produce high-purity, high-performance solid materials.

### Axial Flux Generator Embodiment

In a first embodiment, an axial flux motor/generator configuration is disclosed in which a centrifugal gas compressor rotor is also the rotor of an axial electrical flux motor/generator. In this configuration, the stator of the axial flux device is integrated into the housing of the centrifugal compressor. In another configuration, a separate disk mounted on the gas compressor shaft may serve as the axial electrical flux motor/generator rotor. In yet another configuration, the preceding two configurations may be applied to the gas turbine rotor, although this is less preferable because temperatures associated with the gas turbine are considerably higher than the temperatures associated with its corresponding gas compressor. This embodiment is a compact axial electrical flux generator integrated into a centrifugal gas compressor or radial turbine structure that does not significantly increase the size of the turbo-compressor spool.

A copper clad steel rotor is disclosed in which an axial flux electrical generator rotor is formed by the rear surface of the rotor of a centrifugal gas compressor or radial gas turbine. The stator of the electrical generator is located in the gas compressor or turbine housing. Alternately, the axial flux generator rotor may be a disk located on the gas compressor or turbine shaft between the back of the mechanical rotor and the housing.

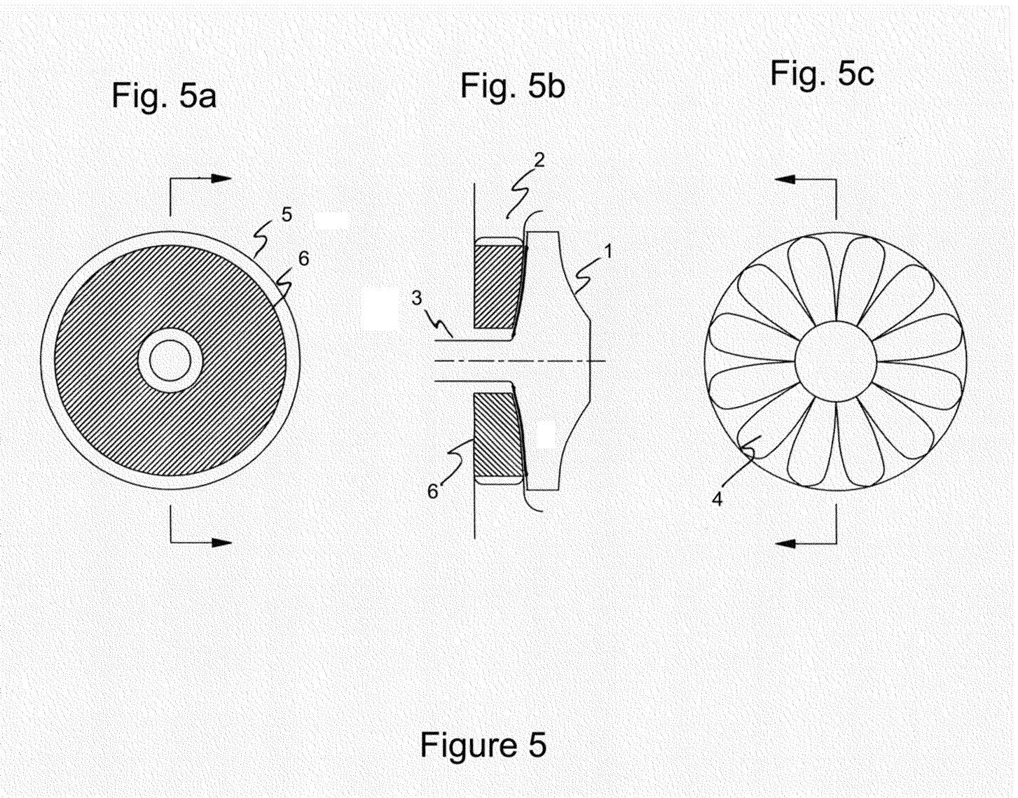

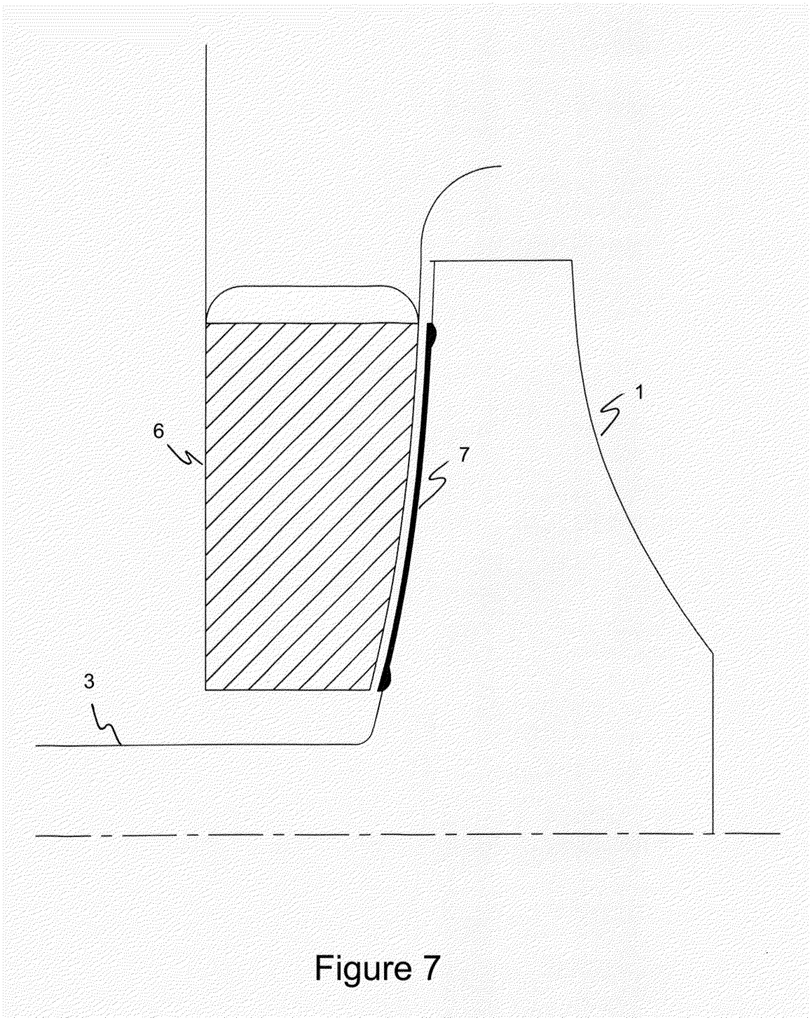

FIG. 5 illustrates a gas compressor rotor and housing configured as a electrical motor/generator rotor and stator. FIG. 5a shows a rear elevation view of the housing 2 that contains the axial flux electrical generator stator 6 and the outer diameter 5 of the mechanical rotor. FIG. 5b shows a side view of the housing 2 which contains the stator 6 and the mechanical rotor 1 on shaft 3. The axial flux electrical generator rotor is formed by a layer of copper cladding on the back of the mechanical turbo-compressor rotor opposite the electrical stator (shown in detail in FIG. 7). FIG. 5c shows a front view of the mechanical rotor illustrating the rotor blades 4.

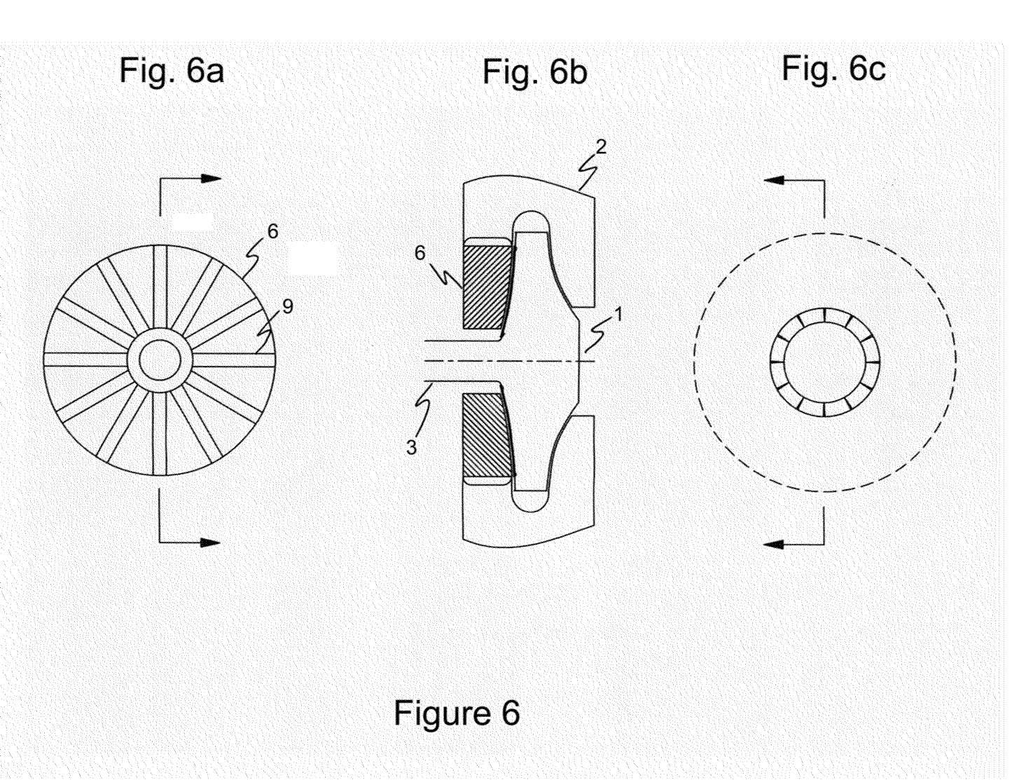

FIG. 6 illustrates another view of a gas compressor rotor and housing configured as an electrical motor/generator rotor and stator. FIG. 6a is another rear elevation view of the of the housing 2 that contains the axial flux electrical generator stator 6 and illustrates the stator winding grooves 9. Twelve winding grooves are shown and these can be wound with suitable high temperature wire such as litz wire and a high temperature insulation (typically capable of operating at about 1,000 degrees Centigrade) to form a 2-pole, 3 phase axial flux electrical generator configuration. FIG. 6b is another side elevation view of the housing 2 which contains the stator 6 and the mechanical rotor 1 on shaft 3. The axial flux generator rotor is formed by a layer of copper cladding on the back of the mechanical turbo-compressor rotor opposite the stator (shown in detail in FIG. 7). FIG. 6c is another front elevation view of the mechanical rotor.

FIG. 7 is a detailed view of a gas compressor rotor and housing configured as an electrical motor/generator rotor and stator. This figure shows mechanical rotor 1 with a copper cladding 7 which forms the electrical generator rotor. As can be seen, the inner and outer diameter of the copper cladding is thickened so as to form an annular low electrical resistance current path. The cladding is typically one thousandth to several thousandths of an inch in thickness with the thickening at the ends being about 2 to about 4 times the thickness in the center of the cladding. The cladding covers an area comparable to the area of the electrical stator material 6.

The mechanical rotor is typically made, for example, from a high grade steel such as for example MAR-M 247 or a titanium alloy. The electrical stator material can be, for example, an amorphous steel, electrical steel or ferrite. The stator is preferably fabricated from a material having a low coercivity (the material's magnetization can easily reverse direction without dissipating much energy through hysteresis losses) and an electrical resistivity to minimize eddy currents.

### High Power, High RPM Electrical Motor/Generator Embodiment

In a second embodiment, an induction motor/generator is disclosed wherein the rotor of the induction electrical motor/generator is solid and is made of copper-clad steel. This construction enables both high rpm (up to about 100,000 rpm) and high power (up to about 400 kW) in a motor/generator that can be directly coupled to the power output shaft of a power turbine of a gas turbine engine. The induction motor/generator with a copper-clad rotor is a high rpm, high-power compact direct-drive induction generator that can eliminate the need for a gear box for an electric or hybrid transmission.

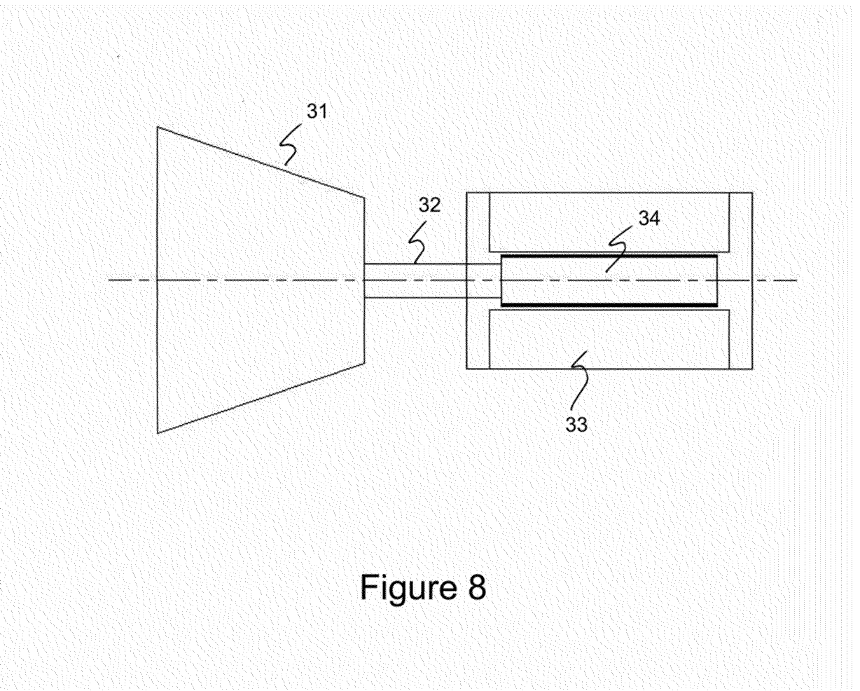

FIG. 8 shows an illustration of an electrical induction machine with a copper-clad solid steel rotor directly coupled to the output shaft of a power gas turbine. The generator depicted in FIG. 8 shows an induction generator similar to prior art induction machines except that the squirrel cage rotor of prior art machines has been replaced by a copper clad steel rotor 34. The electrical generator is shown with rotor shaft 32 directly coupled to the output power shaft of a power gas turbine 31. The electrical generator is comprised of copper clad rotor 34 and stator 33.

Typically, the output of a power turbine for a small gas turbine engine may be about 300 to about 500 kW and the power turbine shaft rpms can be in the range of about 50,000 to about 100,000 rpms. At these power levels and rotational speeds, an axial flux electrical generator would be unsuitable since the power levels required could not be generated without using multiple disks. A prior art electrical generator with a squirrel cage rotor would not be able to tolerate the mechanical stresses associated with the high rpms of such a power gas turbine. However, the copper clad steel rotor depicted in FIG. 8 would be able to handle both the power and rotational speed requirements of a power gas turbine outputting from about 300 to about 500 kW with shaft rpms can be in the range of about 50,000 to about 100,000 rpms.

Such a direct coupled generator would eliminate the need for a reducing gear box and thus eliminate a bulky transmission component for a gas turbine engine used, for example, for vehicular propulsion.

### Induction Generator on a Turbo-Compressor Shaft

In a third embodiment, a electrical induction motor/generator is disclosed in which the shaft of the gas turbo-compressor forms the rotor and the stator also serves as a bearing or damper for the gas turbo-compressor shaft. The electrical induction generator is integrated onto a gas turbo-compressor shaft where the stator of the electrical induction generator can also serve as a bearing or damper.

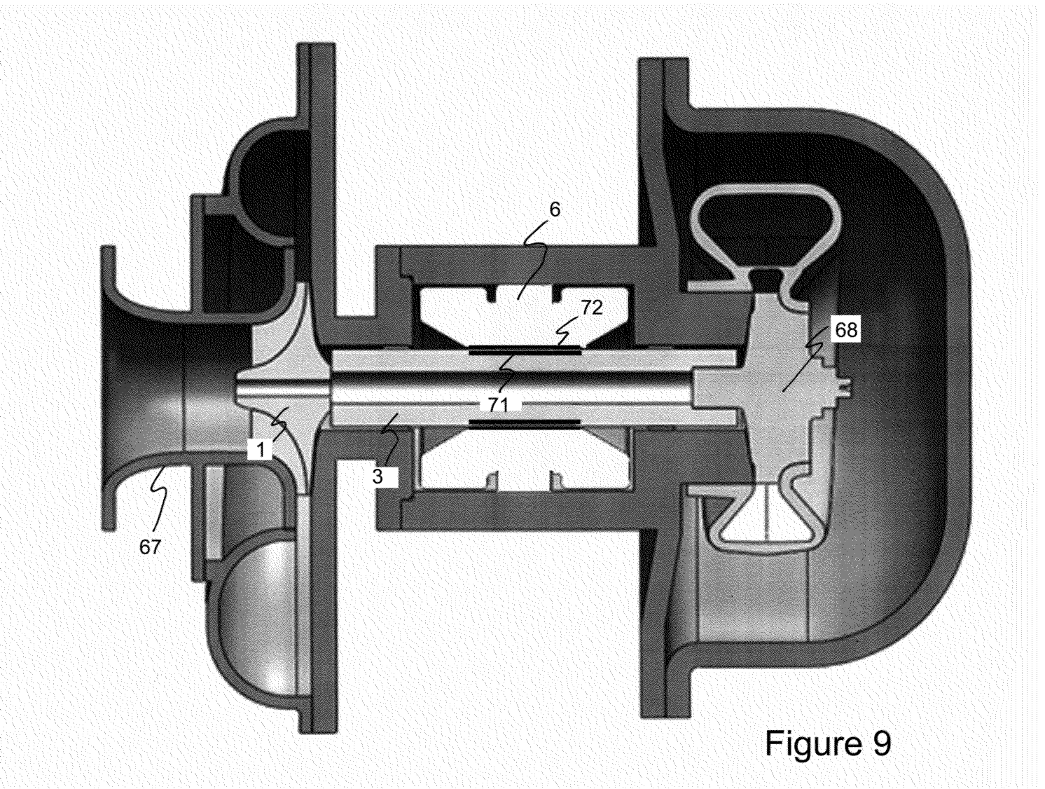

FIG. 9 illustrates an electrical induction motor whose stator forms a bearing for the turbo-compressor spool shaft. In this figure, the shaft 3 is the shaft connecting a gas compressor rotor 1 and a gas turbine rotor 68. The steel shaft has a copper cladded section 71 so that the mechanical spool shaft 3 also serves as an electrical rotor for a small induction motor/generator. The stator 6 of the small induction motor/generator is shown in inside the spool housing. Stator 6 has an inside diameter formed by a material 72 that is suitable for a bearing surface. As can be appreciated, there would be a small clearance gap between the outer diameter of the copper cladding 71 on the electrical rotor and the inner diameter of material 72.

A permanent magnet motor/generator integrated into the shaft of a turbo-compressor spool is described in U.S. Patent Application Publication No. 2013/0139519. This motor/generator was designed for use as a starter motor and as a control device on the high pressure spool by adding or extracting small amounts of power when required. The inventions described in these applications may be incorporated with those described herein.

The motor/generator integrated into the shaft of a turbo-compressor spool shown in FIG. 9 is an induction machine and has the additional advantage that it also functions as the main bearing for the turbo-compressor shaft. The bearing fluid can be oil or air with air being preferable.

In a high rpm application such as a turbo-compressor spool of a gas turbine engine, the shaft on which the gas compressor rotor and gas turbine rotor are mounted will exhibit bending modes as its critical rotational speed is approached. As can be appreciated, the stator can be installed inside standard shaft bearings and function not as a bearing but as a damper of shaft bending as the critical speed of the shaft is approached or achieved. Typically, the critical rotational speed is at the high end of turbo-compressor shaft rpms but can be approached or exceeded if, for example, when the spool rpms are in an over-speed situation.

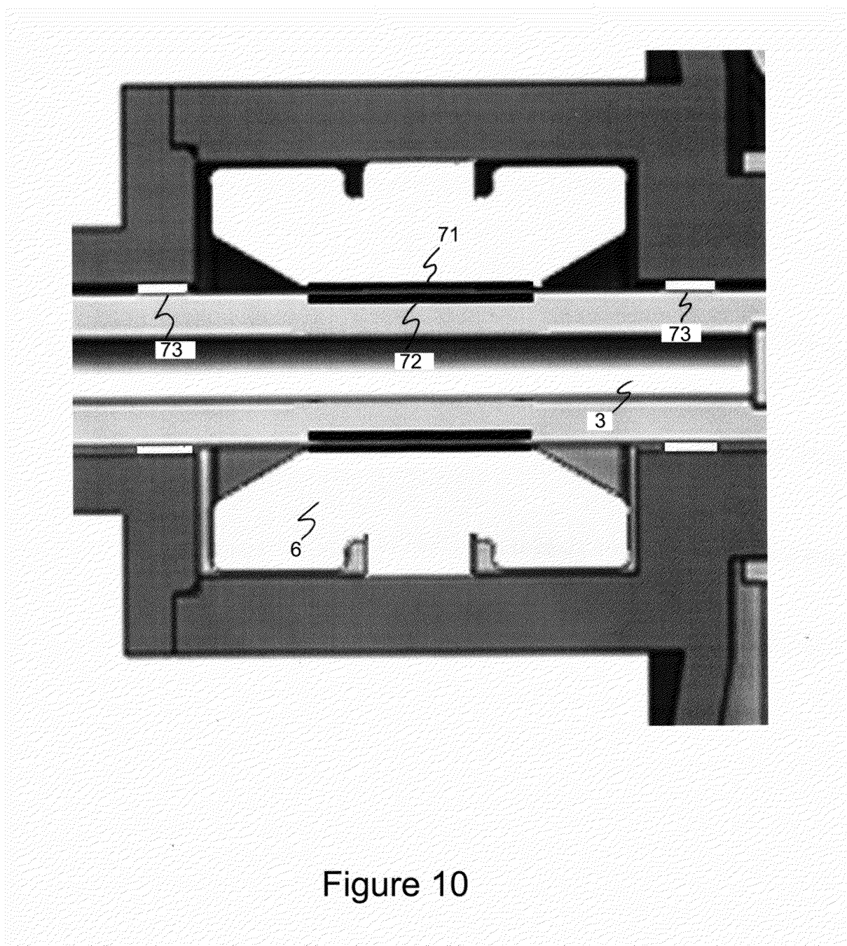

FIG. 10 is a detailed view of an electrical induction motor whose stator also forms a bearing for the turbo-compressor spool shaft. In this figure, shaft 3 connects a gas compressor rotor (not shown) and a gas turbine rotor (also not shown). The steel shaft 3 has a copper cladded section 71 so that the mechanical spool shaft also serves as a rotor for a small electrical induction motor/generator. The stator 6 of the small induction motor/generator is shown in inside the spool housing. Stator 6 has an inside diameter formed by a material 72 that is suitable for a bearing surface.

As mentioned in FIG. 9, the stator can be installed inside standard shaft bearings and function not as a bearing but as a damper of shaft bending as the critical speed of the turbo-compressor shaft is approached or achieved. In the close-up view of FIG. 10, standard shaft bearings 73 are shown and the stator 6 is serving the function of a critical speed damper.

The disclosures presented herein may be used on gas turbine engines used in vehicles or in gas turbine engines used in stationary applications such as, for example, power generation and gas compression.

The disclosure has been described with reference to the preferred embodiments. Modifications and alterations will occur to others upon a reading and understanding of the preceding detailed description. It is intended that the disclosure be construed as including all such modifications and alterations insofar as they come within the scope of the appended claims or the equivalents thereof.

A number of variations and modifications of the disclosures can be used. As will be appreciated, it would be possible to provide for some features of the disclosures without providing others.

The present disclosure, in various embodiments, includes components, methods, processes, systems and/or apparatus substantially as depicted and described herein, including various embodiments, sub-combinations, and subsets thereof. Those of skill in the art will understand how to make and use the present disclosure after understanding the present disclosure. The present disclosure, in various embodiments, includes providing devices and processes in the absence of items not depicted and/or described herein or in various embodiments hereof, including in the absence of such items as may have been used in previous devices or processes, for example for improving performance, achieving ease and\or reducing cost of implementation.

The foregoing discussion of the disclosure has been presented for purposes of illustration and description. The foregoing is not intended to limit the disclosure to the form or forms disclosed herein. In the foregoing Detailed Description for example, various features of the disclosure are grouped together in one or more embodiments for the purpose of streamlining the disclosure. This method of disclosure is not to be interpreted as reflecting an intention that the claimed disclosure requires more features than are expressly recited in each claim. Rather, as the following claims reflect, inventive aspects lie in less than all features of a single foregoing disclosed embodiment. Thus, the following claims are hereby incorporated into this Detailed Description, with each claim standing on its own as a separate preferred embodiment of the disclosure.

Moreover though the description of the disclosure has included description of one or more embodiments and certain variations and modifications, other variations and modifications are within the scope of the disclosure, e.g., as may be within the skill and knowledge of those in the art, after understanding the present disclosure. It is intended to obtain rights which include alternative embodiments to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. A gas turbine engine, comprising:
a combustor operable to combust a fuel and air mixture, the combustor having an inlet and an outlet;
at least one turbo-compressor spool comprising:
a compressor rotor housing,
a compressor rotor positioned within the compressor rotor housing,
a turbine rotor housing,
a turbine rotor positioned within the turbine rotor housing, and
a shaft connecting the compressor rotor and the turbine rotor, the compressor rotor being associated with the combustor inlet and the turbine rotor being associated with the combustor outlet;
wherein at least one of the compressor rotor housing and the turbine rotor housing comprises a stator; and
wherein at least one of a rear surface of the compressor rotor and a rear surface of the turbine rotor has a layer of copper cladding in proximity to the stator, the stator and the cladded rotor defining an electrical axial flux motor/generator.

2. The engine of claim 1, wherein the cladding has an inner diameter positioned near the shaft and an outer shaft disposed outwardly from the shaft and the inner diameter, wherein the thickness of the cladding adjacent the outer diameter is greater than the thickness of the cladding between the inner diameter and the outer diameter.

3. The engine of claim 1, wherein the cladding has an inner diameter positioned near the shaft and an outer shaft disposed outwardly from the shaft and the inner diameter, wherein the thickness of the cladding adjacent the outer diameter diameter is up to four times as thick as the thickness of the cladding between the inner diameter and the outer diameter.

4. The engine of claim 1, wherein the compressor rotor housing includes a stator with a plurality of winding grooves.

5. The engine of claim 4, wherein the winding grooves are comprised of insulated high temperature wire to form a 2-pole, 3 phase axial flux electrical generator.

6. The engine of claim 1, wherein the compressor rotor and the turbine rotor are made of high grade steel and the stator is made of amorphous steel, electrical steel, or ferrite.

7. The engine of claim 1, wherein the stator is made of a material having a low coercivity and an electrical resistivity.

8. A gas turbine engine, comprising:
at least one turbo-compressor spool comprising:
a compressor rotor housing,
a compressor rotor positioned within the compressor rotor housing,
a turbine rotor housing,
a turbine rotor positioned within the turbine rotor housing, and
a shaft connecting the compressor rotor and the turbine rotor;
wherein at least one of the compressor rotor housing and the turbine rotor housing comprises an induction motor; and
wherein at least one of a rear surface of the compressor rotor and a rear surface of the turbine rotor includes at least one permanent magnet, the induction motor and the at least one permanent magnet defining an electrical axial flux motor/generator, wherein an air gap magnetic field is produced by a permanent magnet that induces an electric current in the induction motor when the compressor rotor or turbine is rotated.

9. The engine of claim 8, wherein the compressor rotor housing and the turbine rotor housing include induction motors, and the a rear surface of the compressor rotor and the front surface of the turbine rotor include at least one permanent magnet.

10. The engine of claim 8, wherein the motor/generator is a 3-phase permanent magnet synchronous motor that utilizes six power transistors with independent switching.

11. The engine of claim 10, wherein the six power transistors are selectively activated and deactivated to allow the motor/generator to generate power or to be free-wheeling.

12. The engine of claim 8, wherein the induction motor is a stator with a plurality of winding grooves.

13. The engine of claim 12, wherein the winding grooves are comprised of insulated high temperature wire to form a 2-pole, 3 phase axial flux electrical generator.

14. The engine of claim 12, wherein the compressor rotor and the turbine rotor are made of high grade steel and the stator is made of amorphous steel, electrical steel, or ferrite.

15. The engine of claim 12, wherein the stator is made of a material having a low coercivity and an electrical resistivity.
